(19) United States
(12) Patent Application Publication
(10) Pub. No.: US 2008/0022287 A1
(43) Pub. Date: Jan. 24, 2008

(54) Method And System For Transferring Budgets In A Technique For Restrained Budget Use

(75) Inventor: Reinder Jaap Bril, Waalre (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,372

(22) PCT Filed: Mar. 28, 2005
(86) PCT No.: PCT/IB05/51044

§ 371 Date: Sep. 27, 2006

Related U.S. Application Data
(60) Provisional application No. 60/558,072, filed on Mar. 31, 2004.

(51) Int. Cl. G06F 9/46

(52) U.S. Cl. 718/107

(57) ABSTRACT

A method (10) for controlling multiple tasks in a real-time operating system (30) assigns levels of importance to two or more tasks (31, 32). A first task (31) is assigned to be a More Important Task. A second task (32) is assigned to be a Less Important Task. A Guaranteed Budget Margin is then allocated to the More Important Task along with a More Important Guaranteed Budget. A Less Important Guaranteed Budget is also allocated to the Less Important Task. At some point during execution, the higher level or More Important Task (31) may then determine that the More Important Task no longer requires the Guaranteed Budget Margin, in which case, a Conditionally Guaranteed Budget Margin is then allocated to the Less Important Task (32), but only if the More Important Guaranteed Budget is depleted. If the More Important Guaranteed Budget is not depleted, then the Conditionally Guaranteed Budget Margin is not allocated to the Less Important Task, even though the More Important Task has determined that it does not require the Guaranteed Budget Margin. Provisioning of the Conditionally Guaranteed Budget Margin is enabled in subsequent periods of the More Important Guaranteed Budget by depletion of the More Important Guaranteed Budget. Other aspects of the invention, such as accounting for blocking time, providing spare capacity to lower level tasks at an intermediate priority level, and providing the Conditionally Guaranteed Budget Margin to the LIT at an intermediate priority are included.

The present invention relates generally to methods and apparatuses for managing resources in systems, and more particularly to a method and apparatus for managing resources in an operating system that functions in real-time.

Conditionally Guaranteed Budgets (CGBs) were originally introduced in European Patent Application No. [Attorney Docket No. PHNL000624EPP], which is hereby incorporated by reference as if repeated herein in its entirety, including the drawings. The basic idea behind the CGB is as follows. A more important task (MIT) receives a more important guaranteed budget (MIGB), and, in addition, a guaranteed budget margin (GBM) to anticipate a structural load increase. A less important task (LIT) receives a less important guaranteed budget (LIGB). Moreover, the LIT receives a conditionally guaranteed budget margin (CGBM) when the MIT consistently does not use its GBM. In this type of CGB, the allocation of the CGBM is implicit. We will refer to this type of CGB as weak CGB. The term weak refers to the fact that the guarantee is weak, e.g. the MIT may use (part of) its GBM, and therefore the LIT may receive less than its CGBM.

U.S. Provisional Patent Application No. [Attorney Docket No. 613652] discloses a technique for making the guarantee of the CGB stronger, so we will refer to the latter kind of CGB as strong CGB. The term strong refers to the fact that the guarantee is strong, e.g. the MIT can use its GBM if and only if the MIT claimed the GBM, hence the LIT can then actually count on the CGBM when the MIT releases the GBM. U.S. Provisional Patent Application No. [Attorney Docket No. 613652] is hereby incorporated by reference as if repeated herein in its entirety, including the drawings.

Both strong and weak CGBs have their merits and use in systems. As an example, when an application such as an input reader cannot be scaled and therefore needs a worst-case budget allocation to accommodate its load fluctuations, strong CGBs cannot be applied, and we therefore need weak CGBs if we want to improve the cost-effectiveness of the system.

Before describing further problems with the above, some background is required.

A task can have two types of consumption:
Synchronous behavior: the task works in synchrony with the budget consumption (i.e., the task starts when the budget is replenished, and the task completes its work within the budget period).
Asynchronous behavior: the task does not work in synchrony with its budget. The task may work-ahead, or lag behind, compared to its budget consumption. Asynchronous behavior is often used to smoothen out the load.

European Patent Application No. [Attorney Docket No. PHNL010127EPP, Method of and System for Withdrawing Budget from a Blocking Task, March 2001] is hereby incorporated by reference as if repeated herein in its entirety, including the drawings. This application [Attorney Docket No. PHNL010127EPP] discloses a technique for withdrawing a budget from a task during a blocking period (i.e., when the task is blocked for lack of input or lack of space to output). In certain situations, however, budget withdrawal is not appropriate.

European Patent Application No. [Attorney Docket No. PHNL010828EPP] discloses a technique for allocating a budget surplus to a task, which application is hereby incorporated by reference as if repeated herein in its entirety, including the drawings. In both European Patent Application Nos. [Attorney Docket No. PHNL000624EPP and PHNL010828EPP] it is implicitly assumed that the remainder of a budget during the current period can be withdrawn from a (streaming) task (i.e., a task with asynchronous behavior) when that task blocks on either lack of input or lack of space to store its output. Thus, in the system of these patent applications the implication is that when an MIT completes its current work and new work appears, the MIT has to wait until the next budget period before the MIT can start processing the new work.

CGB Provision is Mixed with Spare Capacity Allocation

When the budget surplus of the MIT is larger than its GBM, the MIT produces additional gain time (i.e., the MIT contributes to the spare capacity). According to the above referenced patent applications, this gain time is also provided to the LIT. However, providing this gain time to the LIT has two disadvantages:

(a) Although CGBs and spare capacity allocation are orthogonal concepts, these patents applications mix both concepts in their description/design. On the one hand, this may be viewed as a strength in the sense that the LIT is compensated in this way for optionally receiving less than its CGBM when the MIT uses (part of) its GBM. On the other hand, it does mean that a spare-capacity manager has less control over the allocation of available spare capacity.

(b) Whenever the LIT is not ready to consume resources (e.g., because the gain time becomes available too early and the LIT is still waiting for input), the LIT will also lose its CGBM without additional precautionary measures due to the withdrawal of the budget (see European Patent Application No. [Attorney Docket No. PHNL010127EPP, Method of and system for withdrawing budget from a blocking task, March 2001], which is hereby incorporated by reference, as if repeated herein in its entirety, including the drawings). Withdrawal of the budget is particularly problematic when the LIT needs its budget on a strictly periodic basis.

Disadvantage (a) does not occur in the system described in U.S. Provisional Patent Application No. [Attorney Docket No. 613652], because CGB provision and spare capacity allocation are properly separated via separate budgets. Disadvantage (b) will be solved in the system of U.S. Provisional Patent Application No. [Attorney Docket No. 613652] when the next problem is solved.

Without appropriate precautionary measures an MIT may not be able to get its GBM back during its current budget period in the system described in U.S. Provisional Patent Application No. [Attorney Docket No. 613652], because the LIT already consumed parts of the CGBM corresponding with that GBM. The system described therein does not guarantee an instantaneous budget transfer back to the MIT when the MIT claims its GBM. The delay between the claim of the GBM and the provision of the GBM may cause an unacceptable temporary reduction of the output quality of the MIT.

The system for handling budget surpluses described in European Patent Application No. [Attorney Docket No. PHNL010828EPP] is not appropriate for strong CGBs, because the MIT is not constrained to its MIGB, amongst others. Hence, an improvement of this system is needed to cover the system set forth in U.S. Provisional Patent Application No. [Attorney Docket No. 613652] as well.

The present invention is therefore directed to the problem of developing a method and apparatus for improving resource use in an importance-based system while solving the above-mentioned problems and disadvantages.

The present invention solves these and other problems by providing among other things for strong CGBs that the Conditionally Guaranteed Budget Margin is enabled only upon depletion of the More Important Guaranteed Budget, thereby ensuring that when the Guaranteed Budget Margin is reclaimed by the More Important Task during its consumption of the More Important Guaranteed Budget, the Guaranteed Budget Margin can be instantaneously (and entirely) transferred back to the More Important Task, i.e., during the current budget period of the More Important Task.

Thus, according to one aspect of the present invention, once the More Important Task has determined that it does not require the Guaranteed Budget Margin in the current budget period and subsequent budget periods until further notice, the Conditionally Guaranteed Budget Margin is then enabled during subsequent budget periods only upon depletion of the More Important Guaranteed Budget. This enables instantaneous reclamation of the Guaranteed Budget Margin by the More Important Task during the period when the More Important Task is consuming the More Important Guaranteed Budget because the Conditionally Guaranteed Budget Margin has not yet been provided to the Less Important Task. Moreover, the Guaranteed Budget Margin can be reclaimed during the current budget period in the normal manner, which only requires notice to the Less Important Task and the normal delay between reclaiming of the Guaranteed Budget Margin and the provision of the Guaranteed Budget Margin (and of course, the possibility that the Guaranteed Budget Margin is less than the maximum amount depending upon how much of the Conditionally Guaranteed Budget Margin was consumed by the Less Important Task).

In addition, the present invention also solves some of the above-mentioned problems by providing a method for controlling multiple tasks in a system, in which the time a task remains blocked is accounted to a budget associated with the task and while the task remains blocked, the budget is maintained with the blocked task.

Moreover, the present invention also solves some of the above-mentioned problems by providing a method for controlling multiple tasks in a system, in which gain time is provided to a gain time consumer at a lower priority than a priority of a gain time producer but at a higher priority than a priority of a next regular budget.

Other aspects of the present invention will become apparent to those of skill in the art upon a review of the detailed description in light of the following drawings.

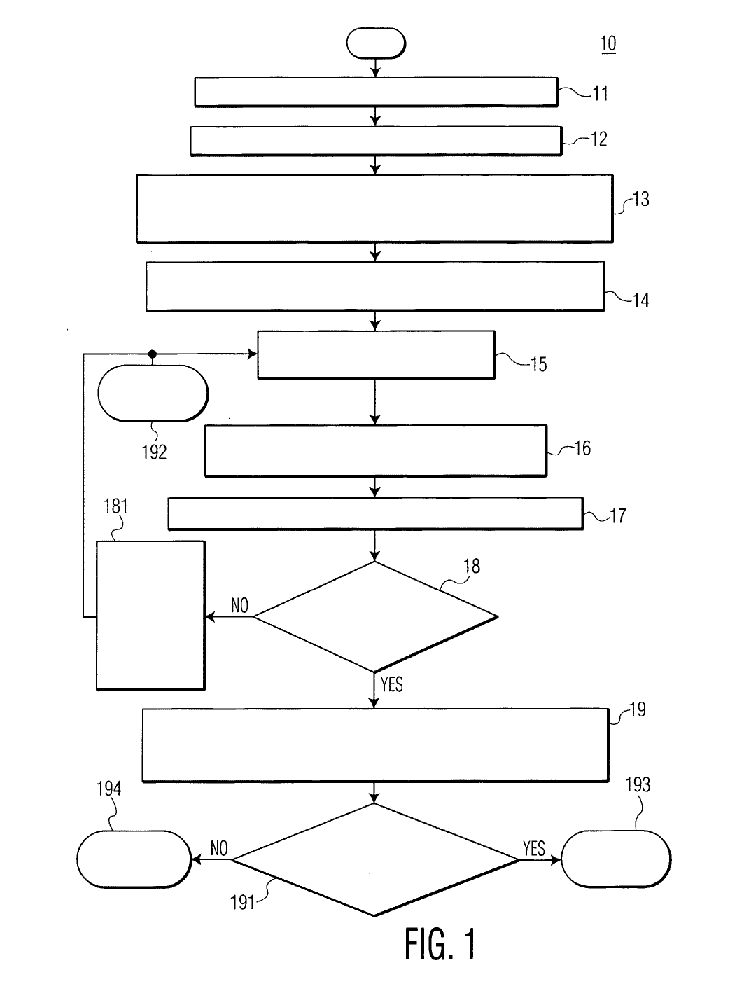

FIG. 1 depicts an exemplary embodiment of a method for controlling multiple tasks in a system, such as a real-time operating system in an electronic component, according to one aspect of the present invention.

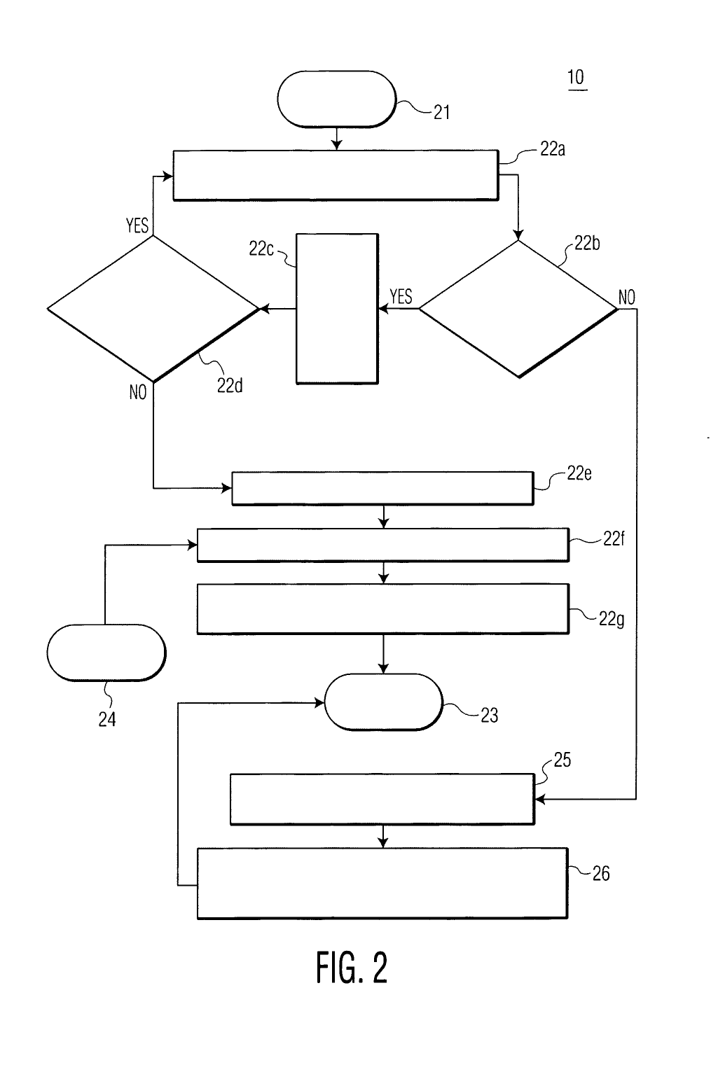

FIG. 2 depicts another exemplary embodiment of a method for controlling multiple tasks in a system, such as a real-time operating system in an electronic component, according to another aspect of the present invention.

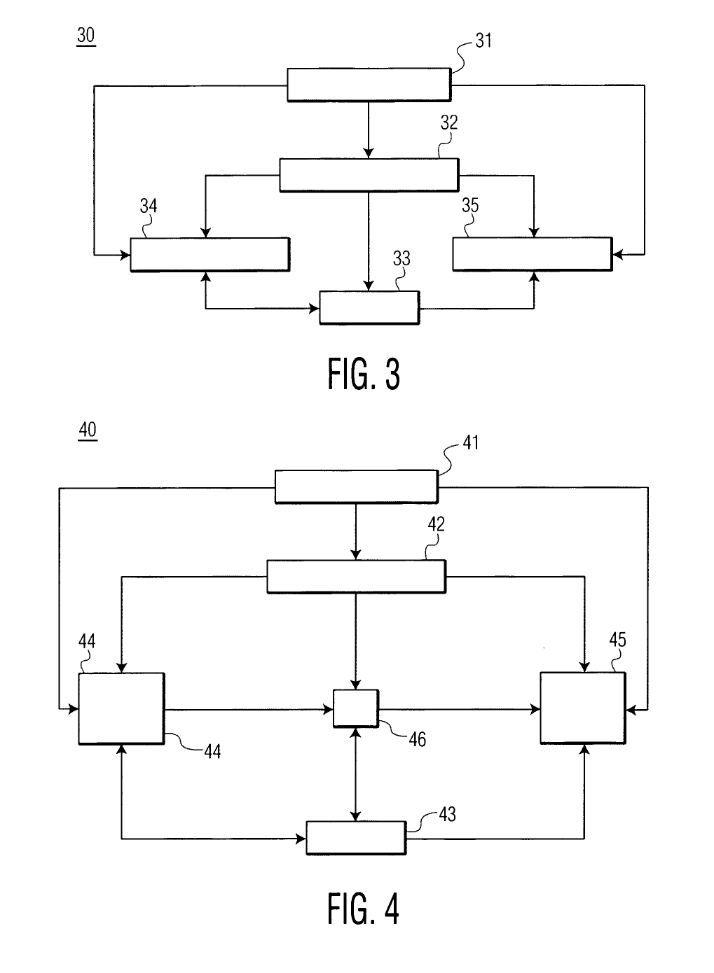

FIG. 3 depicts an exemplary embodiment of an apparatus for controlling multiple tasks in a system, such as a real-time operating system in an electronic component, according to still another aspect of the present invention.

FIG. 4 depicts another exemplary embodiment of an apparatus for controlling multiple tasks in a system, such as a real-time operating system in an electronic component, according to yet another aspect of the present invention.

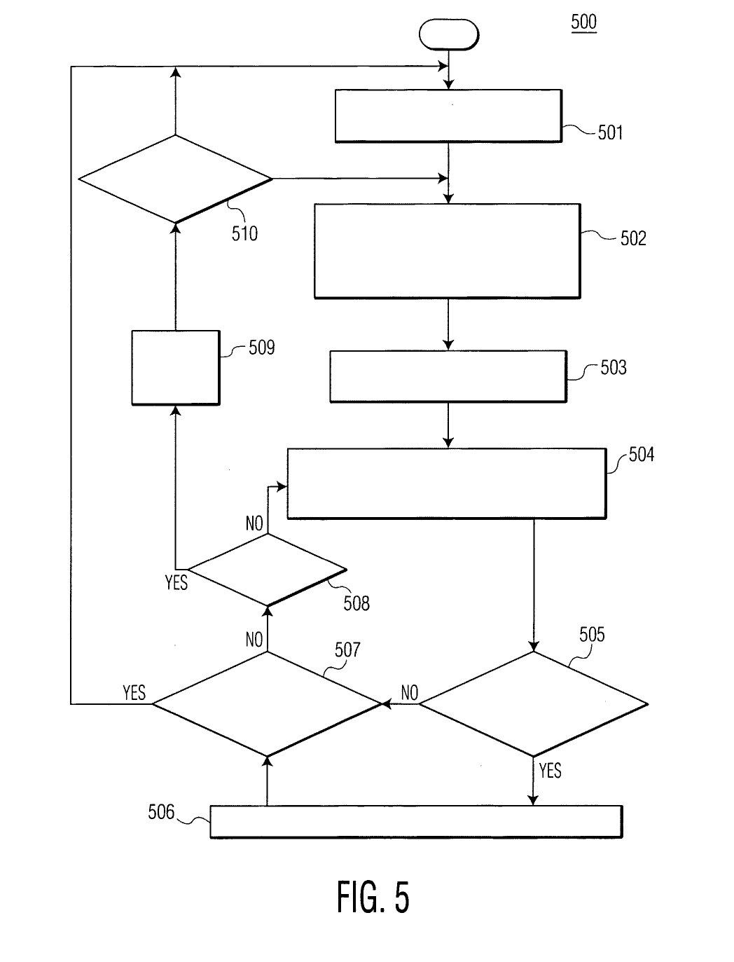

FIG. 5 depicts still another exemplary embodiment of a method for controlling multiple tasks in a system, such as a real-time operating system in an electronic component, according to still another aspect of the present invention.

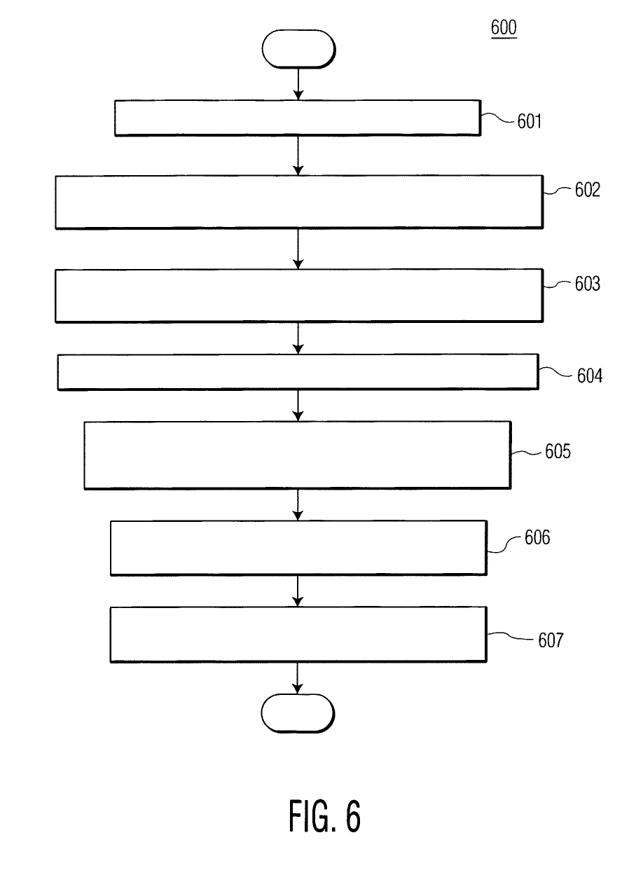

FIG. 6 depicts yet another exemplary embodiment of a method for controlling multiple tasks in a system, such as a real-time operating system in an electronic component, according to yet another aspect of the present invention.

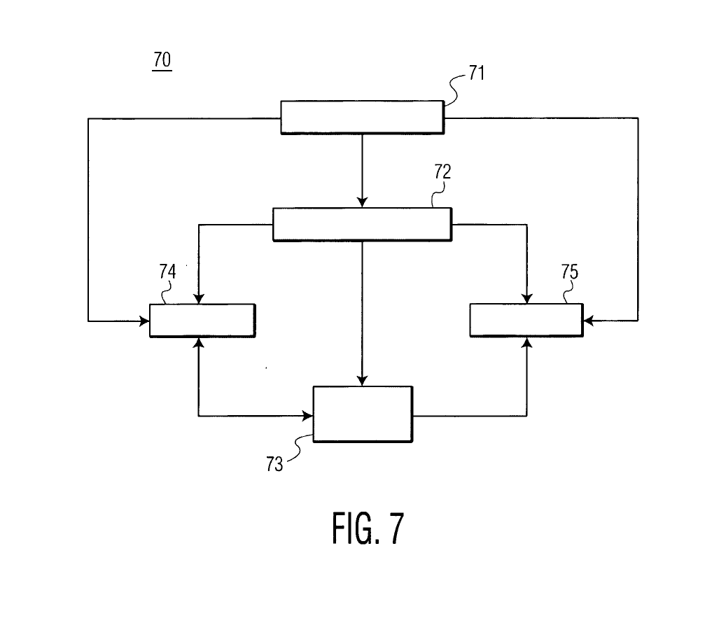

FIG. 7 depicts an exemplary embodiment of an apparatus for controlling multiple tasks in a system, such as a real-time operating system in an electronic component, according to still another aspect of the present invention.

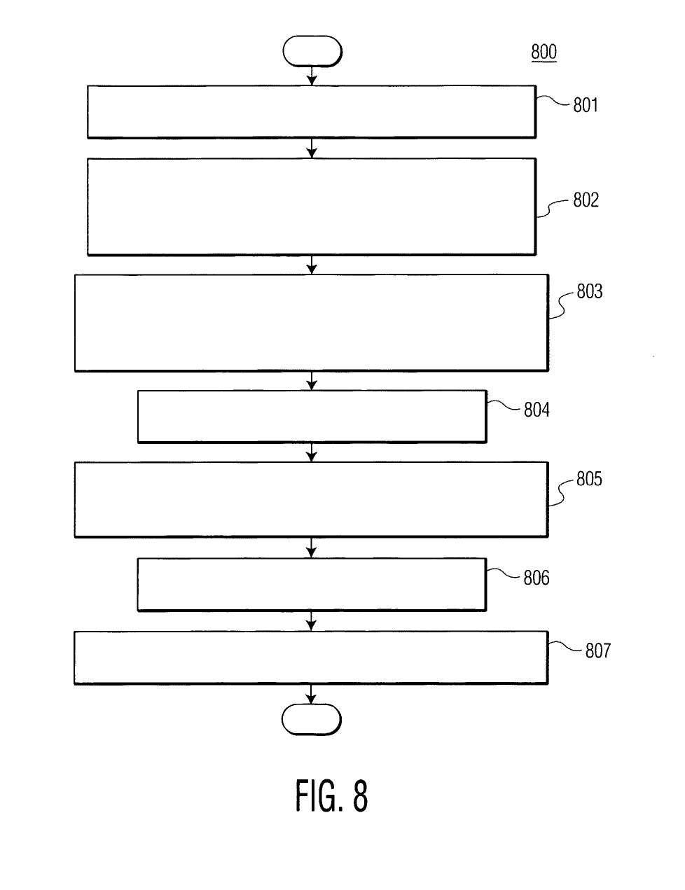

FIG. 8 depicts yet another exemplary embodiment of a method for controlling multiple tasks in a system, such as a real-time operating system in an electronic component, according to yet another aspect of the present invention.

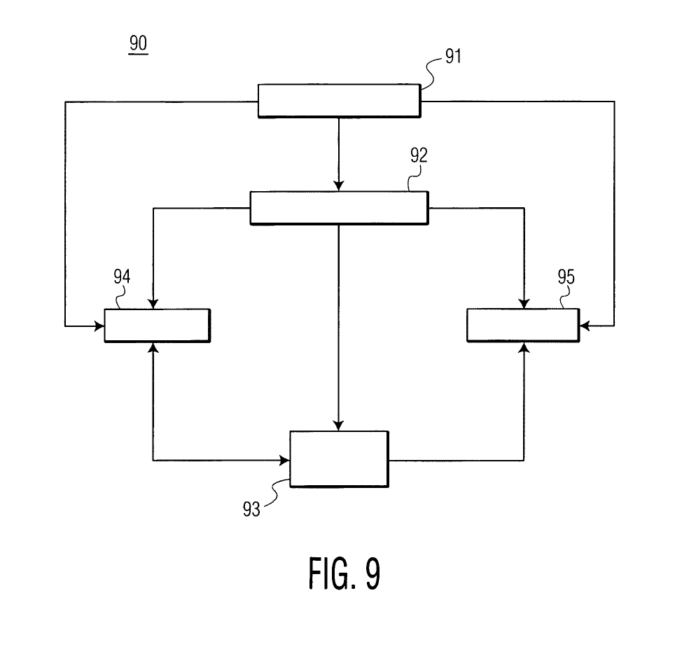

FIG. 9 depicts an exemplary embodiment of an apparatus for controlling multiple tasks in a system, such as a real-time operating system in an electronic component, according to still another aspect of the present invention.

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Media processing in software for Multimedia Consumer Terminals (MCT's) is required to be cost-effective, while preserving typical qualities of high volume production electronic devices, such as robustness, predictability, and stability. Cost-effectiveness requires that the resources are allocated, provided, and used effectively, towards the goal of maximizing the overall Quality of Service (QoS). One exemplary embodiment combines application adaptation and QoS-based resource management. Applications running on an MCT can be in a number of different modes. Adaptive applications can operate at different quality levels within an application mode, allowing run-time trade-offs between output quality and resource usage by controlling the operational quality. A resource estimate is associated with each quality level in each application mode. The applications are responsible for both effective and efficient resource usage for media processing.

The basis of the QoS approach is constituted by a software framework for QoS-based resource management. This framework includes a combination of a multi-layer control hierarchy and a reservation-based resource manager.

The control hierarchy is responsible for effective, dynamically adjusted, re-source allocation, and for effective use of the allocated resources. Overall effectiveness is realized by dynamically maximizing the overall QoS.

The optimization is based on the momentarily available mappings from quality levels to resource needs of the applications, and also takes the relative importance of applications into account. By selecting a quality level for an application, the control hierarchy determines the operational setting at which that application is expected to run. The control hierarchy addresses stability by choosing appropriate time scales for the control layers.

The resource manager is responsible for efficient resource provision. The re-source manager addresses robustness and predictability by providing guaranteed resource budgets, which are based on resource reservation. Resource reservation in operating systems improves robustness and predictability and is a basis for QoS management. It is based on four components: admission control, scheduling, accounting, and enforcement. When combined properly, they provide guaranteed reservations. Resource budgets are allocated to so-called resource consuming entities (RCEs), which are active components consisting of one or more tasks. The resource manager complements resource provision through budgets by mechanisms for spare-capacity provision. Spare-capacity originates from unused (and reclaimed) reservations (so-called gain time) and from time that has not been allocated by means of resource reservation (so-called slack time).

CPU budgets are provided by the resource manager, but other system resources can also be applied using the techniques herein. The resource manager is built on top of a commercial-off-the-shelf (COTS) real-time operating system (RTOS). The CPU resource reservation is based on the fixed-priority scheduling (FPS) model used by that RTOS, and the admission test is based on rate monotonic analysis (RMA). The system strives for a processor utilization that exceeds existing utilization bounds. A CPU resource reservation based on earliest deadline first (EDF) is also possible.

The guaranteed CPU budgets provide temporal isolation between applications. However, in order to obtain robustness, the applications have to contribute as well. Due to the close-to-average-case resource allocation, and given the dynamic load fluctuations, applications will be faced with temporal (or stochastic) and structural (or systematic) overloads. The resulting robustness problems have to be resolved by the applications themselves. Stated in other words, the applications have to get by with their budget. To this end, an adaptive application trades output quality and resource usage, by controlling its operational quality level. Such application-specific control resides at the lowest layer of the control hierarchy.

The embodiments herein can be applied to single processor systems for scalable video and scalable 3D graphics, as well as distributed systems.

The embodiments herein support a set of adaptive applications. For ease of presentation, it is assumed that each application consists of a single resource consuming entity (RCE), and that each RCE consists of a single task, unless explicitly stated otherwise. The multilayer control hierarchy consists of at least two layers. The lower layer contains the specific controllers of the applications, which reside within the RCEs, and the higher layer contains a single controller, being the so-called ‘quality manager’ (QM). Moreover, a reservation-based resource manager is provided that contains a ‘budget scheduler’ (BS). The QM selects quality levels at which the RCEs are executed and allocates CPU budgets to RCEs in such a way that the overall system utility is maximized, and the estimated resource requirements meet the resource availability. Next to performing this global optimization, the QM maintains the quality mappings from the running RCEs based on the resource needs provided by the Budget Scheduler (BS). Changes in the number of applications, relative importance of the applications, and quality mappings of the RCEs require re-optimizations. The scheduler provides CPU budgets to RCEs. These budgets are time-triggered and strictly periodic. Budgets are implemented by means of priority manipulations. Budget accounting and enforcement is based on timers.

The scheduler is based on rate monotonic scheduling (RMS), and therefore suffers from scheduling imperfections, and the system will typically have slack time. Moreover, it is conceivable to explicitly reserve (slack-) time for overload handling through judicious spare-capacity allocation.

The term CGB-provider is used for the RCE that provides the CGB and CGB-consumer for the RCE that consumes the CGB. The CGB provider requires an MIGB in a normal mode, and an additional budget margin (GBM) in an anticipated mode. Conversely, the CGB consumer requires an LIGB in an anticipated mode and is granted an additional budget margin (CGBM) with a conditional guarantee in normal mode.

The LIT receives a CGB with a strictly periodic budget. In an instance the entire budget margin is provided to the LIT as CGBM, the LIT is (implicitly) allowed to consume all gain time corresponding with the remainder of the budget margin. In an instance the remainder of the budget margin becomes available when both RCEs have consumed their budgets, i.e., as late as possible. It is left to a spare-capacity manager to provide the spare capacity to either of the RCEs. In this case, the spare capacity becomes available when the CGB consumer has depleted its CGB and there is still budget margin left, i.e., during the time intervals that it is produced. Classification of this spare capacity as either slack-time or gain-time may depend on the particular perspective taken. It may be classified as slack-time from a ‘scheduling imperfection’ point of view, and as gain-time from a ‘remainder-of-the-budget-margin’ point of view. Note that the design of a mechanism that provides gain time at the time it is produced is the equivalent of the in-the-place-of design for CGBs.

Budgets are implemented by means of priority manipulations. In-budget execution is performed at high priority, and out-of-budget execution is done at low priority. This gives rise to two main priority bands, a high-priority band (HP) for in-budget executions and a low-priority band (LP) for out-of-budget executions (i.e., spare capacity consumption). An RCE that consists of multiple tasks gives rise to a sub-priority band, so that tasks within the RCE can be prioritized. Priority bands of RCEs are disjoint (i.e., they do not overlap). Budgets are periodic, and the budget periods may be different for each RCE. In HP, the RCEs are scheduled in rate-monotonic priority order, i.e., RCEs with smaller budget periods get higher priorities. At the start of each new period, the budget is replenished, and the priority of an RCE is raised to its rate-monotonic priority within HP. When the budget is exhausted the RCE's priority is lowered to LP. In case of a multi-task RCE, the complete sub-priority band is raised or lowered, leaving the internal priority ordering intact.

In one implementation, the gain-time of RCEs only becomes available for out-of-budget execution in LP, i.e., as late as possible. We therefore call this mechanism latest gain-time provision.

As a basis for our in-the-place-of gain-time mechanism, we view a budget as a server, and associate a budget with a sub-priority band in HP. Apart from the RCE that owns the budget and performs in-budget execution at the sub-priority band of its budget, every RCE with a priority lower than that sub-priority band is also allowed to run on that budget. An RCE therefore effectively shares its budget with all RCEs with a lower priority. Hence, when the owning RCE releases the processor, the RCE with the highest priority lower than the owning RCE is allowed to execute on the owning RCE's budget till either it releases the processor or the budget is exhausted. In summary, at any time the execution of the RCE with the highest priority is accounted to the highest priority (non-depleted) budget, where the system maintains an invariant guaranteeing that the sub-priority band of the executing RCE is at most equal to the sub-priority band of the accounted budget. This basic mechanism only facilitates default (i.e., implicit) gain-time provision, and is therefore called implicit in-the-place-of gain-time provision. Note that the replacement of the latest gain-time provision mechanism by the implicit in-the-place- of gain-time provision mechanism influences budget accounting, but does not influence priority manipulations of RCEs.

According to one aspect of the present invention, a sub-priority band is provided for gain-time provision for every sub-priority band in the higher priority, where the sub-priority is positioned immediately below the high priority. Unlike the high priority, there is no budget associated with the sub-priority; introduction of the intermediate priority is meant for gain-time provision only. A spare-capacity manager can subsequently explicitly allocate the gain-time of the owner of a budget associated with a lower priority to an RCE by raising the priority of that RCE to the intermediate priority. This mechanism is called explicit in-the-place-of gain-time provision.

We assume that all gain-time of the CGB-provider will be provided to the CGB consumer for weak CGBs, i.e., gain-time from both the budget as well as budget margin. We therefore can apply the same approach as described for explicit in-the-place-of gain-time provision to implement in-the-place-of CGB provision for weak CGBs, i.e., reserve an additional sub-priority band in HP immediately below the sub-priority band of the main budget of the CGB-provider, and executions of the CGB consumer at CGB in HP are accounted to the main budget of the CGB provider. Note that in this setting, the CGB is consumed at a lower priority level than the main budget, unlike the description in European Patent Application No. [Attorney Docket No. PHNL01028EPP].

According to one aspect of the present invention, the CGBM is enabled by depletion of the MIGB, which ensures that when the GBM is claimed back by the MIT during its consumption of the MIGB, the GBM can be instantaneously (and entirely) transferred back to the MIT, i.e., during the current period of the MIT. Note that the CGBM is consumed at the same priority as the MIGB and the GBM, as described in European Patent Application No. [Attorney Docket No. PHNL01028EPP]. Without precautionary measures as provided by certain aspects of the present invention, the CGBM may therefore be consumed before the depletion of the MIGB, i.e., either before the consumption of the MIGB has started or during the consumption of the MIGB, e.g., when the MIT temporarily releases the processor during its consumption of the MIGB. Thus, certain aspects of the present invention prevent this consumption of the CGBM before or while the MIGB is being consumed during subsequent budget periods once the MIT has released the GBM but before the MIT has reclaimed the GBM.

Turning to FIGS. 1 and 2, shown therein is an exemplary embodiment 10 of a method for controlling multiple tasks in a system. Examples of applicable systems include real-time scheduling for media processing in software in high volume electronics (HVE) multimedia consumer terminals (MCTs), such as digital TV sets, digitally enhanced analog TV sets, and set-top boxes (STBs). The present invention can be applied to other systems as well though and its applicability is not limited to these examples.

At the heart of this embodiment 10 exists a technique for enabling provision of a Conditionally Guaranteed Budget Margin (CGBM) to a Less Important Task (LIT) based on depletion of a More Important Guaranteed Budget (MIGB) by a More Important Task. While some steps are set forth in the methods herein for context purposes, some of these steps could be skipped or other steps could be added to this technique without departing from the scope of the invention.

In element 11, a first task is assigned to be a More Important Task (MIT). This MIT is a task that is considered simply more important than at least one other task. An Application Manager may inform the MIT of its designation as the MIT. Other devices in the system could also perform this informing.

In element 12, a second task is assigned to be a Less Important Task (LIT). This LIT is simply a task that is considered simply less important than the MIT, but may be more important than any other task in the system. Typically, an Application Manager that directs the relative levels of importance of the various tasks performs these assignments, however, other devices in the system may perform these tasks depending upon the system architecture. The Application Manager may inform the LIT of its designation as the LIT. Other devices in the system could also perform this informing.

In element 13, a Guaranteed Budget Margin (GBM) is allocated to the More Important Task along with a More Important Guaranteed Budget (MIGB) and the MIT is explicitly informed of these allocations. In some applications, it may not be necessary to explicitly inform the MIT of these allocations though depending upon the system architecture.

In element 14, a Less Important Guaranteed Budget (LIGB) is allocated to the Less Important Task along with a Conditionally Guaranteed Budget Margin (CGBM) and the LIT is explicitly informed of this allocation. As with the MIT, it may not be necessary to explicitly inform the LIT of these allocations in all cases. Moreover, various devices in the system may perform the step of informing the MIT and LIT depending upon the system architecture. For example, as shown in FIG. 3, an Allocation Mechanism may inform the LIT and MIT of these allocations.

In element 15, the More Important Guaranteed Budget and the Guaranteed Budget Margin are provided to the MIT and the Less Important Guaranteed Budget is provided to the LIT. These budgets and budget margins can be provided by various devices in the system, however, a scheduler is often used to provide these budgets and budget margins, as shown in FIG. 3.

In element 16, the MIT determines that the MIT no longer requires its GBM (in other words, the MIT voluntarily restrains its budget usage). This determination could be made for the current budget period or for one or more subsequent budget periods. Typically, the MIT makes this determination. It remains possible, however, that another device in the system could make this determination on behalf of the MIT based on prior consumption and upcoming tasks.

In element 17, a message is sent that the MIT no longer requires its GBM. This message could be sent by the MIT to the scheduler, or by the scheduler to a central controller or allocation mechanism or to some other device (such as the Application Manager) in the system. The important aspect here is that a message is explicitly sent so that subsequent steps can occur with this information in hand. Below in element 19, the LIT is informed after the MIT releases the GBM (and, of course, the MIT has not reclaimed the GBM) and the MIGB has been depleted, i.e., which is the initial situation for the provision of the CGBM.

In element 18, the determination is made as to whether the MIGB is depleted or not while the MIT has still not reclaimed the GBM. Either the MIT can make this determination or another element in the system, such as the scheduler or allocation mechanism. The scheduler typically determines this because the MIT need not be aware of the depletion of the MIGB, e.g., when the MIT runs asynchronously. However, another device in the system may be used to track the MIGB budget consumption depending upon the system architecture.

If the MIGB is depleted and the GBM still has not reclaimed the GBM (as determined in element 18), then in element 19 the Guaranteed Budget Margin is no longer provided to the MIT, and the Conditionally Guaranteed Budget Margin is provisioned to the Less Important Task and the MIT and LIT is explicitly informed of these provisions. If the MIGB is depleted and the GBM has been reclaimed by the MIT (as determined in element 18), then in element 181 the process moves to element 24 in FIG. 2. It should be noted that at this stage, the LIT did not receive the CGBM, i.e., not even a single period, and the scheduler keeps providing the GBM to the MIT in the normal manner.

In step 191, if the CGBM was provided to the LIT in step 19, and the MIGB budget period expires without the GBM being reclaimed by the MIT, then the process 10 moves to element 193, which goes to element 21 in FIG. 2.

In step 191, if the CGBM was provided to the LIT in step 19, and the MIGB budget period does not expire without the GBM being reclaimed by the MIT, then the process 10 moves to element 194, which goes to element 24 in FIG. 2. In such a situation, the MIT reclaimed the GBM during spare capacity consumption (i.e., during out-of-budget execution).

Turning to FIG. 2, in element 21, the process 10 arrives from FIG. 1, element 193. Even if the MIT has released the GBM, the CGBM is never provided to the LIT before depletion of the MIGB in a budget period. Thus, FIG. 2 depicts a loop with an explicit test (element 22b) whether or not the MIGB has been depleted during each budget period of the MIGB without the GBM being reclaimed by the MIT.

In element 22a, at the start of a new budget period for the MIGB, the CGBM is disabled, i.e., no longer provided to the LIT (even if previously the MIT released the GBM and the CGBM was provided to the LIT as a result of depletion of the MIGB in that MIGB budget period). In element 22b, if the MIGB is depleted without the GBM being reclaimed by the MIT, then in element 22c the CGBM is then enabled, i.e., provided to the LIT. Stated in other words, the depletion of the GBM “triggers” the provision of the CGBM.

In element 22b, if the GBM is reclaimed by the MIT before depletion of the MIGB, then the process 10 moves to element 25.

In element 22d, if the MIGB budget period ends without the GBM being reclaimed by the MIT, the process 10 moves to element 22a and the loop begins anew. If in element 22d, the GBM is reclaimed by the MIT before the MIGB budget period ends (but now after the MIGB was depleted and therefore the CGBM was provided to the LIT), the process moves to element 22e, in which the MIT determines it requires the GBM, a message is then sent (element 22f) that the MIT requires the GBM, and the CGBM is then removed from the LIT and the GBM is provided to the MIT and the LIT is explicitly informed of the withdrawal of the CGBM (element 22g). The process then returns to element 192 in FIG. 1 (via connection element 23).

Thus, in element 23 (which returns the process to element 192, FIG. 1), the MIGB and GBM are provided to the MIT, and the LIGB is provided to the LIT.

As shown in FIG. 2, according to one aspect of the present invention during every subsequent budget period (after release of the GBM by the MIT) of the MIGB, depletion of the MIGB (element 22b—without of course reclamation of the GBM by the MIT) triggers the provision of the CGBM to the LIT (element 22c). Element 22b represents the trigger for the provision of the CGBM during a budget period of the MIGB. When the MIGB is used up during a budget period (exit labeled “YES” of 22b), the CGBM is provided to the LIT during that same budget period (element 22c).

When the MIT claims the GBM during the budget period in element 25, i.e., the MIGB is not used up (exit labeled “NO” of element 22b), the CGBM will no longer be provided to the LIT during subsequent budget periods, however, at this stage, the provision of the CGBM during this budget period of the MIGB did not yet start. Hence, the budget transfer can be done both instantaneously and completely during the current budget period of the MIGB. The LIT is explicitly informed about the withdrawal, and the GBM is provided to the MIT (element 26). The process continues at element 23.

In element 23, the process moves to FIG. 1, element 192.

In element 24, the process arrives from FIG. 1, element 194. Thus, in element 24 the process arrives there from element 194 while in the same MIGB budget period and before the MIGB has been depleted, whereas if the process arrives in element 25 from element 22b the process is in a different budget period for the MIGB. In both cases (same MIGB budget period or different MIGB budget period), the MIGB has not been depleted and the subsequent response is the same, i.e., the GBM is instantly available to the MIT because the CGBM was never provisioned to the LIT in the current budget period. FIG. 3 shows an exemplary embodiment 30 of the roles and the interactions of the various processes discussed herein. A first task 34 has a first importance level, which first task 34 is called a More Important Task. This higher task 34 can include either a task external to the operating system 30 or internal to the operating system 30.

A second task 35 has a second importance level lower than the first importance level. This lower task (or Less Important Task) 35 can include either a task external to the operating system 30 or internal to the operating system 30. Moreover, the second task 35 is merely lower in importance than the first task 34, but could even be the second most important task to be executed. In these two paragraphs all importances are relative importance. An application manager 31 assigns the levels of importance and informs the various tasks of their assignments (elements 11, 12) and informs the allocation mechanism of these assignments (elements 11, 12).

An allocation mechanism 32 is included to allocate budgets of resources among the various tasks 34, 35 to be performed by the operating system 30. According to one aspect of the present invention, the allocation mechanism 32 explicitly informs the first task 34 about a More Important Guaranteed Budget and a Guaranteed Budget Margin (element 13). The More Important Guaranteed Budget is the amount of resources or other limited availability items set aside for use by the first task 34. The Guaranteed Budget Margin is the amount of resources or other limited availability items set aside for use by the first task 34 above and beyond the More Important Guaranteed Budget in case needed by the first task 34.

The allocation mechanism 32 also explicitly informs the second task 35 about a Less Important Guaranteed Budget and a Conditionally Guaranteed Budget Margin (element 14). The Less Important Guaranteed Budget is the amount of resources or other limited availability items set aside for use by the second task 35. The Conditionally Guaranteed Budget Margin is the amount of resources or other limited availability items set aside for use by the second task 35 above and beyond the Less Important Guaranteed Budget in case needed by the second task 35, but which amount is only provided when not needed elsewhere, such as by the More Important Task 34. The allocation mechanism also informs the scheduler as to the allocations (elements 13, 14).

A scheduler 33 controls provisioning of the budgeted amounts of resources to the various tasks 34, 35 to be performed by the operating system 30, including the first task 34 and the second task 35. The scheduler 33 provides the More Important Guaranteed Budget plus the Guaranteed Budget Margin to the first task 34 at a first possible occasion (element 15). The scheduler also provides the Less Important Guaranteed Budget to the second task 35 at a first possible occasion (element 15).

If the first task 34 determines at some point during execution that the first task 34 can execute properly with the More Important Guaranteed Budget only, the first task 34 explicitly informs the scheduler 33 that the first task 34 does not require its Guaranteed Budget Margin (element 17).

At this point, the determination is made as to whether the More Importance Guaranteed Budget is depleted or not. According to one aspect of the present invention, depletion of the MIGB is used to initiate the provision of the Conditionally Guaranteed Budget Margin to the second task. If the MIGB is not depleted before the MIT claims the GBM again (element 25), the provision of the CGBM is not enabled and the second task does not receive the CGBM. If the MIGB is depleted, then the CGBM is enabled (element 19) and the CGBM can be provided to the second task (element 19). The provisioning of the CGBM (element 22c) is enabled in each subsequent MIGB budget period by depletion of the MIGB (as determined in element 22b, assuming the MIT has not reclaimed the GBM).

Upon enabling provisioning of the CGBM, the scheduler 33 stops providing the Guaranteed Budget Margin to the first task 34 at a first possible occasion and starts providing the Conditionally Guaranteed Budget Margin to the second task 35 at a first possible occasion (element 22c). After this, the scheduler 32 informs the second task 35 of the granting of the Conditionally Guaranteed Budget Margin (element 22c). Once the provision of the Conditionally Guaranteed Budget Margin is initiated, it will be provided upon the depletion of the More Important Guaranteed Budget during subsequent periods of the More Important Guaranteed Budget (element 22b), i.e., in which case depletion of the More Important Guaranteed Budget (element 22b) automatically triggers the provision of the Conditionally Guaranteed Budget Margin, which involves informing the MIT and the LIT of these provisions (element 22c).

Subsequently, the first task 34 may determine at some point during execution that the first task 34 requires the Guaranteed Budget Margin as well, in which case the first task 34 explicitly informs the scheduler 33 that the first task 34 does require its Guaranteed Budget Margin (element 22f, element 25, or element 181).

An application manager 31 assigns and de-assigns the MIT role to a given task (element 11 of FIG. 1). The application manager also assigns and de-assigns the LIT role to another given task (elements 12). The application manager 31 then becomes inactive while the allocation mechanism 32 becomes active. When the MIT and LIT roles expire, the application manager 31 becomes active again, while the allocation mechanism 32 becomes inactive. The allocation mechanism 32 allocates the MIGB and the GBM to the MIT and explicitly informs the MIT of these allocations (element 13 of FIG. 1). The allocation mechanism 32 also allocates the LIGB and the CGBM to the LIT and explicitly informs the LIT of these allocations (element 14 of FIG. 1). The allocation mechanism 32 sends the reservation to the scheduler 33, which activates the scheduler process, which executes to completion. The scheduler 33 accepts reservation commands for the LIT and the MIT from the allocation mechanism; grants the MIGB and GBM to the MIT; and also grants the LIGB to the LIT. The scheduler then runs in accordance with a scheduling algorithm. The scheduler 33 receives a message from the MIT that the MIT no longer requires the GBM. The scheduler then grants only the MIGB to the MIT, informs the LIT of the budget increase, and grants the LIGB and the CGBM to the LIT (element 19 of FIG. 1). The scheduler 33 may subsequently receive a message from the MIT that the MIT now requires its GBM (element 22e of FIG. 1).

Turning to FIG. 4, shown therein is an exemplary embodiment 40 of the interaction of the various processes according to another aspect of the present invention. An application manager 41 assigns and de-assigns the MIT role to a given task (element 11 of FIG. 1). The application manager also assigns and de-assigns the LIT role to another given task (element 12). The application manager 41 then becomes inactive while the allocation mechanism 42 becomes active. The allocation mechanism 42 allocates the MIGB and the GBM to the MIT and explicitly informs the MIT of these allocations (element 13). The allocation mechanism 42 also allocates the LIGB and the CGBM to the LIT and explicitly informs the LIT of this allocation (element 14).

The allocation mechanism 42 sends the reservation to the CBM 46. The CBM sends the reservation to the scheduler process, which executes to completion. The CBM receives messages from the MIT that the MIT no longer requires the GBM (element 17) and messages from the MIT that the MIT now requires the GBM (elements 22f, 25). In turn, the CBM sends messages, respectively, to the LIT that the CGBM is available (element 19) and that the CGBM is no longer available (element 22g). In addition, the CBM 46 sends reservation changes to the scheduler and receives acknowledgements from the scheduler. The scheduler 43 accepts reservation commands for the LIT and the MIT from the CBM, grants the MIGB and GBM to the MIT (element 22g) and also grants the LIGB to the LIT. The scheduler then runs in accordance with a scheduling algorithm. Changes in the reservations are sent by the scheduler 43 to the LIT and MIT. The scheduler 43 sends acknowledgements of these changes to the sender.

Under the prior approaches, when a task is blocked the budget is withdrawn from the blocked task. As used herein the blocking time of the task is the time that a task is blocked and one or more lower importance tasks are executing.

In contrast to the prior approaches, according to one aspect of the present invention, rather than withdrawing the budget from a task when the task is blocked, the blocking time is accounted to the budget of the task being blocked. The lower importance tasks execute on their own budget when available. Accounting the blocking time to the budget of the task being blocked effectively delays the moment in time that this blocked time becomes available for (spare capacity) consumption. By so doing, the present invention prevents a blocked task that becomes unblocked from failing to execute during a current budget period. Thus, a task that become momentarily blocked and then becomes unblocked during a current budget period can resume with little penalty in performance other than a small consumption of its budget than otherwise would occur.

As an extension of this technique, a variable or adjustable limit or threshold can be placed on the blocking time that is accounted to a blocked task's budget to prevent significant consumption of a budget by a blocked task. Under this approach, budget withdrawal and reallocation to other tasks would occur as set forth in European Patent Application Nos. [Attorney Docket No. PHNL010127EPP] and [Attorney Docket No. PHNL010828EPP].

Implementation of this technique requires that the blocked task informs the scheduler (or other device in the system depending upon the system architecture) as to its blocked status, the length of which may be monitored. However, the budget remains provided to the blocked task during this period in the normal manner so additional steps are not required. Once the blocked task becomes unblocked, normal consumption of the budget resumes although the blocking time has been deducted from the budget of the blocked task as if the blocked task was consuming the budget in the normal manner even though the blocked task was blocked. The usual levels of importance between the tasks remain in force so that if the budget of the blocked task is consumed by the blocked task when accounting for blocking time while the task remains blocked, other tasks may be initiated in the normal manner. When the budget of the blocked task is replenished, the blocked task may become unblocked due to circumstances relating to the blocking or the blocked task may remain blocked, in which case the blocked time is again accounted to the blocked task's budget (but only to the extent that the blocking time occurs when the blocked task would otherwise be consuming its budget).

Turning to FIG. 5, shown therein is an exemplary embodiment 500 of a method for controlling multiple tasks in a system.

It should be noted that accounting for blocking time can be applied for both weak and strong CGBs, whereas the current description only covers strong CGBs. Moreover, the same methods “accounting for blocking time” holds for consumption of the GBM, whereas it is now only described for the consumption of the MIGB. Strictly speaking, accounting for blocking time is completely independent of CGBs. As a result, it is sufficient to look at a single task and a generic type of budget in FIG. 5, and the need for importance levels vanishes.

As with some of the other embodiments herein, in element 501, the budget is provided to a task at the start of a new budget period. In this embodiment 500, those devices described above in the other embodiments may perform elements 501.

In element 502, the task becomes blocked. This can occur for a variety of reasons, such as lack of input or space to send output.

In element 503, the task sends a message that the task is blocked. Sending a message is not always necessary, however, doing so can permit monitoring of the blocking period by the scheduler or some other device in the system to ensure proper functioning. For example, if a task remains blocked for an unduly length of time, corrective action or reallocation of the blocked task's budget may be desirable. The task may send the message to the scheduler or to another device to monitor the blocking time. In element 504, the blocking time is accounted to the budget of the task in the normal manner as if the budget were being consumed by the task. In fact, since the budget is not being withdrawn from the task at this point, the task continues to consume its budget even though the task remains blocked.

In element 505, the blocking time is monitored to determine if the blocking time exceeds some predetermined threshold. The scheduler or other device may perform this monitoring.

If the blocking time exceeds the predetermined threshold (which may be infinite, so there essentially is no threshold), the prior techniques referred to above for implementing budget withdrawal may be implemented as in element 506.

If the threshold is not exceeded, the process moves to element 507, in which the determination is made as to whether the budget period has expired for the blocked task. The scheduler or other device in the system can perform this determination.

If the budget period has expired as determined in element 507, the process 500 returns to element 501, where the budget is replenished. The scheduler may perform this determination.

In element 502 then, the MIT may continue to be blocked from the prior budget period or may become blocked again, in which case the process 500 continues as described above. If the budget period has not expired as determined in element 507, the blocked process is monitored in element 508 to determine if the process becomes unblocked. If not, the blocking time continues to be accounted to the budget of the task (as in element 504) and the blocking time continues to be monitored (as in element 505).

If the task becomes unblocked as determined in element 508, the task resumes consumption of its budget in the normal manner (as in element 509) because the budget period has not expired and continues to do so until blocked (as determined in element 510, which returns the process to element 502 or until the budget period ends as determined in element 510, which returns the process to element 501.

The same apparatuses shown in FIGS. 3-4 can be used to implement the method 500 set forth in FIG. 5.

According to still another aspect of the present invention, gain time is provided to a gain time consumer at a lower priority than a priority of a gain time producer, but at a higher priority than a priority of a next regular budget.

As used herein, priorities are different than relative importance. Priority manipulation is a method for providing budgets in a resource allocation scheme. Hence, priorities are a mechanism local to a budget scheduler, and those priorities are typically provided by the operating system. Priorities are not available above the level of the budget scheduler. This ensures the guarantees of budgets because if an application was able to change priorities, the application might corrupt the guarantees of budgets. In contrast, relative importance is an issue that is taken into account by the application manager. Various applications have a relative importance among themselves. Relative importance has an influence of the size of budgets, and the quality levels selected for given applications.

A budget margin provided to the MIT is guaranteed (GBM). A budget margin provided to the LIT is conditionally guaranteed (CGBM). Both budget margins are determined semi-statically (i.e., they are determined as part of the admission test of budgets). In contrast, gain time is not conditionally or otherwise guaranteed to any task. Gain time originates from time that is available for a task, but is not used by that task. Gain-time becomes available at run-time. As a result, that time can be dynamically provided to and used by another task, and the decision which task is allowed to use that gain-time is made by, for example, a spare-capacity manager. Hence, it is up to the spare capacity manager to provide gain-time to tasks based on an appropriate strategy. Both the MIT and LIT may receive gain-time (e.g. from other tasks) in addition to their budgets.

Thus, an intermediate priority level is reserved for gain time consumption. In this way, the producer of the gain time can regain its budget when needed, even during the current budget period. Moreover, gain time consumption and allocation does not interfere with the provision of any lower-priority budget, or with the provision of other types of spare time.

According to still another aspect of the present invention, a dedicated server is provided for every budget, in which the original budget “owner” has the highest priority, and gain time consumers have lower priorities, each of which is assigned by, for example, a spare-capacity manager. Finally, note that production of gain time does not change the scheduling of the budgets, but changes which task consumes the budget.

Turning to FIG. 6, shown therein is an exemplary embodiment of a method for controlling resource allocation among two tasks. The same approach can be applied to more than two tasks by simply allocating intermediate levels of priority between multiple tasks so that gain time is always consumed at a priority level higher than that of the next task but lower than the gain time producer.

In element 601, a first task is assigned a first priority. A budget scheduler typically performs this assignment.

In element 602, a second task is assigned a second priority. A budget scheduler also typically performs this assignment.

In element 603, an intermediate priority is established for gain time consumption, which intermediate priority lies between the first and second priorities. The budget scheduler also controls this intermediate priority assignment.

At some point during execution, the first task may complete its work with extra time remaining in its budget (i.e., gain time). Thus, in element 604, the budget scheduler may then determine that gain time is available for re-allocation. The budget scheduler can determine this if the first task indicates to the budget scheduler that it has completed its work, as the budget scheduler knows how much time remains allocated to the first task in the current budget period.

As such, in element 605 the budget scheduler can then allocate this gain time to another task, such as the second task having an execution priority lower than the first task. According to one aspect of the present invention, this gain time is then allocated to the second task at an intermediate priority level higher than the priority level of the second task but lower than the first task. This ensures that the second task consumes the gain time before consuming its budget. Moreover, this allocation at the intermediate priority level also ensures that the first task can reclaim the remainder of its (excluding the consumed gain time) without interfering with other budget assignments.

Thus, in element 606 the first task may determine it no longer has any gain time available because, for example, it now needs to restart its execution as new work has arrived during the current budget period or a quality level increase requires additional effort. This can be accomplished by sending a message from the first task to the budget scheduler, which inherently knows (because the budget scheduler keeps track) where in the budget period the first task currently exists and how much time remains. As such, the budget scheduler then knows that no gain time (from the first task) remains available for consumption by other tasks.

Thus, in element 607 the gain time is returned to the first task. This is accomplished by stopping the second task execution of the gain time at the intermediate level and reassigning the gain time to the first task at the first priority level.

Turning to FIG. 7, shown therein is an exemplary embodiment 70 of an apparatus for controlling multiple tasks 74, 75 in a system, such as a real-time operating system in an electronics component. The system 70 includes a budget scheduler 73 and at least two tasks 74, 75 operating in accordance with a budget and budget period. One task 74 is assigned a higher priority than the other task 75. The task 74 with the higher priority may determine at some point that it has gain time available (or that it has completed its work) and notifies the budget scheduler 73, which then allocates this gain time to another task 75, such as the second task 75. The gain time is allocated to the second task 75 at an intermediate priority level higher priority than the budget of the second task 75 but at a lower priority than the budget of the first task 74.

As before, an application manager 71 assigns and de-assigns the importance levels to tasks one 74 and task two 75. The application manager 71 then becomes inactive while the allocation mechanism 72 becomes active. The allocation mechanism 72 allocates the various budgets and budget margins (conditional and guaranteed) to the tasks 74, 75 and explicitly informs them of these allocations.

The allocation mechanism 72 sends the reservation to the scheduler process 73, which executes to completion. The scheduler 73 then sends gain time to the second task 75 in the intermediate priority when the first task 74 completes its work with time remaining in the budget. Moreover, the scheduler 73 returns gain time to the first task 74 when the first task 74 has previously released gain time but now requires it. The scheduler also assigns the various priorities among the task 74, 75.

In general, the apparatus 70 ensures that the gain time is consumed at a higher priority level than the next task in line (the second task 75 in this embodiment 70) but at a lower level than the gain time producer (the first task 74 in this embodiment 70). Moreover, the budget scheduler 73 ensures that the remainder of the budget (excluding the consumed gain time) is returned to the first task 74 when needed with as little disruption as possible.

According to yet another aspect of the present invention, a CGBM is provided to a CGB-consumer for weak CGBs without using the same priority as for the MIGB and GBM for the CGB-provider. According to previous implementations, the budget surplus of the CGB-provider (i.e., the MIT) was provided to the CGB-consumer (i.e., the LIT) with scheduling characteristics of the MIT, and those characteristics “correspond with a period and a priority of the [budget of the] first task.”

According to this aspect of the present invention, as an alternative for the provision of the CGBM rather than providing the CGBM at the same priority as the MIGB and GBM, the CGBM is provided at another, lower priority. This priority is below the priority of the MIGB and GBM, but higher than the priority of any other budget. Stated in other words, the CGBM is provided at an intermediate priority level. As a result, the mechanism to provide weak CGBs is similar to the mechanism for “in-the-place-of” gain-time provision to another task (or RCE).

CGBs and gain-time are dealt with by different entities in the system. The GBM and CGBM are allocated by the allocation mechanism to the MIT and the LIT, respectively. The scheduler subsequently provides the GBM and CGBM to the MIT and the LIT, respectively. As described earlier, the CGBM is provided to the LIT conditionally, i.e., if and only if the MIT does not need its GBM. Because both the MIT and LIT are informed about their guaranteed budgets (MIGB and LIGB) and budget margins (GBM and CGBM) as well as their quality levels, CGBs allow for controlled quality improvements.

Gain-time just becomes available at run-time because an RCE does not need its budget entirely. This can happen when, for example, the amount of processing time needed to process input data is less than expected (i.e., the “load” of an RCE typically depends on its input data for streaming applications such as media processing). Gain-time can be provided implicitly (i.e., by means of a default setting) or explicitly (i.e., by a spare-capacity manager). Unlike CGBs, gain-time is not allocated, but only provided. For weak CGBs, a CGB-consumer may not receive the entire CGBM because the CGB-provider is always allowed to use parts of its GBM. Stated in other words, unlike strong CGBs, the CGB-provider is never constrained to its MIGB only for weak CGBs. It is therefore assumed for weak CGBs that all gain-time of the CGB-provider (i.e., gain-time from both the MIGB and the GBM) is made available to the CGB-consumer. As a result, other RCEs are only allowed to consume gain-time of the MIT when the LIT does not need it. Hence, CGBM-consumption takes place at a priority level immediately below that of the MIGB and GBM. The gain-time surplus (i.e. gain-time of the MIT that is not consumed by the LIT) is provided to yet other RCEs at a priority level immediately below that of the CGBM-consumption.

Accounting for blocking supports gain-time provision with the option to re-claim the remainder of the budget during the current budget period when needed.

Accounting for blocking is needed in general for any budget to be able to guarantee that an RCE can immediately get the remainder of its budget back during its current budget period when it needs is, thereby stopping the gain-time provision.

In particular, it is needed for CGBs:
For both weak CGBs and strong CGBs to be able to guarantee that the MIT can immediately get the remainder of its MIGB back during its current budget period when it needs is, and the LIT its LIGB, thereby stopping the gain-time provision.
In case of weak CGBs to make sure that the MIT can immediately get the remainder of its GBM back when it needs it.
In case of strong CGBs when the CGB-provider has a claim on its GBM to make sure that the MIT can immediately get the remainder of its GBM back when it needs it.
In case of both weak and strong CGBs to be able to guarantee that the LIT can immediately get the remainder of its CGBM back during its current budget period when it needs it.

Without accounting for blocking, the CGBM may become available too early for the LIT in case of weak CGBs (in which case the LIT would loose its CGBM according to the current patents).

Turning to FIG. 8, shown therein is yet another exemplary embodiment 800 of a method for controlling multiple tasks in a system. Only those steps significant to this aspect of the invention are shown in this embodiment. Other steps may be performed as well.

In element 801, a first execution priority level is assigned to consumption of a first budget and a guaranteed budget margin by a first task.

In element 802, a second execution priority level is assigned to consumption of a second budget by a second task, which second execution priority level is different (higher or lower) than the first execution priority level.

In element 803, an intermediate execution priority level is established for consumption of a conditionally guaranteed budget margin by the second task, which intermediate execution priority level is immediately below the first execution priority level.

In element 804, it is determined that the first task does not require the guaranteed budget margin.

In element 805, the conditionally guaranteed budget margin is provided to the second task at the intermediate execution priority level immediately below the first execution priority level.

In element 806, it is determined that the first task now requires the guaranteed budget margin.

In element 807, the guaranteed budget margin is returned (or reallocated) to the first task for consumption by the first task at the first execution priority level.

Turning to FIG. 9, shown therein is an exemplary embodiment 90 of an apparatus for controlling multiple tasks 94, 95 in a system, such as a real-time operating system in an electronics component. The system 90 includes a budget scheduler 93 and at least two tasks 94, 95 operating in accordance with a budget and budget period. Budget consumption (and consumption of guaranteed budget margin) by one task 94 is assigned a higher execution priority level than the budget consumption by the other task 95. The task 94 with the higher execution priority level for consumption of its budget may determine at some point that it no longer requires its guaranteed budget margin (or that it has completed its work) and notifies the budget scheduler 93, which then allocates the conditionally guaranteed budget margin to another task 95, such as the second task 95. The consumption of the conditionally guaranteed budget margin is allocated to the second task 95 at an intermediate execution priority level, which is at a level immediately below the priority level of the priority of the task 94.

As before, an application manager 91 assigns and de-assigns the importance levels to tasks one 94 and task two 95. The application manager 91 then becomes inactive while the allocation mechanism 92 becomes active. The allocation mechanism 92 allocates the various budgets and budget margins (conditional and guaranteed) to the tasks 94, 95 and explicitly informs them of these allocations.

The allocation mechanism 92 sends the reservation to the scheduler process 93, which executes to completion. The scheduler 93 then provides the conditionally guaranteed budget margin to the second task 95 in the intermediate execution priority level when the first task 94 completes its work with time remaining in the budget. Moreover, the scheduler 93 returns or provides the guaranteed budget margin to the first task 94 when the first task 94 has previously released the guaranteed budget margin but now requires it. The scheduler also assigns the various priorities (higher, intermediate, lower) among the task 94, 95.

In general, the apparatus 90 ensures that the conditionally guaranteed budget margin is consumed at a higher priority level than the next task in line (the second task 95 in this embodiment 90) but at a lower level than the consumption of the guaranteed budget margin or budget of the first task 94. Moreover, the budget scheduler 93 ensures that the remainder of the budget margin (excluding that which is the consumed as the conditionally guaranteed budget) is returned to the first task 94 when needed with as little disruption as possible.

Although the discussion herein suggests fixed-priority preemptive scheduling (FPPS), the ideas can be applied equally well in combination with deadline driven scheduling, such as earliest deadline first (EDF).

Although various embodiments are specifically illustrated and described herein, it will be appreciated that modifications and variations of the invention are covered by the above teachings and are within the purview of the appended claims without departing from the spirit and intended scope of the invention. For example, certain terms and protocols are employed, however, other names and protocols could be used without departing from the scope of the present invention. Furthermore, this example should not be interpreted to limit the modifications and variations of the invention that are covered by the claims but is merely illustrative of possible variations.

1. A method (10) for controlling multiple tasks in a system comprising:
provisioning (19) a Conditionally Guaranteed Budget Margin to a second task having an importance lower than a first task when said first task releases a Guaranteed Budget Margin; and
enabling (18) provision of the Conditionally Guaranteed Budget Margin by depletion of a More Important Guaranteed Budget in a current More Important Budget period and subsequent More Important Budget periods.

2. The method (10) according to claim 1, further comprising:
assigning (11) the first task to be a More Important Task.

3. The method (10) according to claim 1, further comprising:
assigning (12) the second task to be a Less Important Task.

4. The method (10) according to claim 2, further comprising:
allocating (13) a Guaranteed Budget Margin to the More Important Task along with a More Important Guaranteed Budget and explicitly informing the More Important Task of this allocation.

5. The method (10) according to claim 3, further comprising:
allocating (14) a Less Important Guaranteed Budget to the Less Important Task and explicitly informing the Less Important Task of this allocation.

6. The method (10) according to claim 5, further comprising:
allocating (14) conditionally the Conditionally Guaranteed Budget Margin to the Less Important Task and explicitly informing the Less Important Task of this allocation.

7. The method (10) according to claim 4, further comprising:
determining (16) that the More Important Task no longer requires its Guaranteed Budget Margin.

8. The method (10) according to claim 7, further comprising:
sending (17) a message that the More Important Task no longer requires its Guaranteed Budget Margin.

9. The method (10) according to claim 8, further comprising:
allocating (19) the Conditionally Guaranteed Budget Margin to the Less Important Task only if the More Important Guaranteed Budget is depleted.

10. The method (10) according to claim 9, further comprising:
determining (18) whether the More Important Guaranteed Budget is depleted.

11. The method (10) according to claim 9, further comprising:
determining (22e) that More Important Task does require its Guaranteed Budget Margin.

12. The method (10) according to claim 11, further comprising:
sending (22f) a message that the More Important Task does require its Guaranteed Budget Margin.

13. The method (10) according to claim 11, further comprising:
removing (22g) the Conditionally Guaranteed Budget Margin from the Less Important Task and providing the Guaranteed Budget Margin to the More Important Task.

14. The method (10) according to claim 13, further comprising:
explicitly (22g) informing the Less Important Task of removal of the Conditionally Guaranteed Budget Margin.

15. The method (10) according to claim 1, further comprising:
immediately (26) allocating the Guaranteed Budget Margin to the first task if the More Important Guaranteed Budget is not depleted.

16. The method (10) according to claim 1, further comprising:
immediately (26) providing the Guaranteed Budget Margin to the first task if the Conditionally Guaranteed Budget Margin has not been allocated to the second task.

17. An apparatus (30) comprising:
a first task (34) having a first importance level;
a second task (35) having a second importance level lower than the first importance level;
an allocation mechanism (32) to allocate budgets of resources, said allocation mechanism (32) explicitly informing the first (34) task about a More Important Guaranteed Budget and a Guaranteed Budget Margin and explicitly informing the second task (35) about a Less Important Guaranteed Budget and a Conditionally Guaranteed Budget Margin; and
a scheduler (33) providing the budgeted amounts to the first and second tasks (34, 35), said scheduler (33) providing the More Important Guaranteed Budget plus the Guaranteed Budget Margin to the first task (34) at a first possible occasion and providing the Less Important Guaranteed Budget to the second task (35) at a first possible occasion, wherein upon the first task (34) determining at some point during execution that the first task (34) can execute properly with the More Important Guaranteed Budget only, said first task (34) explicitly informing the scheduler (33) that the first task (34) does not require its Guaranteed Budget Margin;
wherein the scheduler (33) stops providing the Guaranteed Budget Margin to the first task (34) at a first possible occasion;
wherein if the first task (34) has not depleted the More Important Guaranteed Budget the scheduler (33) does not provide the Conditionally Guaranteed Budget Margin to the second task (35) and if the first task (34) has depleted the More Important Guaranteed Budget then the scheduler (33) provides the Conditionally Guaranteed Budget Margin to the second task (35);
wherein upon providing the Conditionally Guaranteed Budget Margin to the second task (35) the scheduler (33) informs the second task (35) of the providing the Conditionally Guaranteed Budget Margin;
wherein the first task (34) determines at some point during execution that the first task (34) requires the Guaranteed Budget Margin as well and the first task (34) explicitly informs the scheduler (33) that the first task (34) does require its Guaranteed Budget Margin;
wherein the scheduler (33) immediately transfers the Guaranteed Budget Margin to the first task (34) if the Conditionally Guaranteed Budget Margin was not provided to the second task (35) because when the Guaranteed Budget Margin was previously released the More Important Guaranteed Budget Margin was not depleted; and
wherein the scheduler (33) informs the second task (35) that the Conditionally Guaranteed Budget Margin will be withdrawn if the Conditionally Guaranteed Budget Margin was provided to the second task (35) because when the Guaranteed Budget Margin was previously released the More Important Guaranteed Budget Margin was depleted, in which case the scheduler (33) stops providing the Conditionally Guaranteed Budget Margin to the second task (35) at a first possible occasion and the scheduler (33) starts providing the Guaranteed Budget Margin to the first task (34) at a first possible occasion.

18. The apparatus (30) according to claim 17, wherein depletion of the More Important Guaranteed Budget enables provision of the Conditionally Guaranteed Budget Margin in one or more subsequent More Important Guaranteed Budget periods.

19. An apparatus (40) comprising:
a first task (44) having a first importance level;
a second task (45) having a second importance level lower than the first importance level;
an allocation mechanism (42) to allocate budgets of resources, said first task (44) being explicitly informed about a More Important Guaranteed Budget and a Guaranteed Budget Margin and said second task (45) being explicitly informed about a Less Important Guaranteed Budget and a Conditionally Guaranteed Budget Margin;
a conditional budget monitor (46) to monitor an availability of the Conditionally Guaranteed Budget Margin, said conditional budget monitor (46) to receive a message that the More Important Task (44) no longer requires the Guaranteed Budget Margin, to receive a message that the More Important Task (44) now requires the Guaranteed Budget Margin, to receive budget allocations of the Guaranteed Budget Margin, the Conditionally Guaranteed Budget Margin, the More Important Guaranteed Budget and the Less Important Guaranteed Budget from the allocation mechanism (42), and to send out a reservation command regarding the budget allocations; and
a scheduler (43) providing the budgeted amounts to the first and second tasks (44, 45) based on the reservation command, said scheduler (43) providing the More Important Guaranteed Budget plus the Guaranteed Budget Margin to the first task (44) at a first possible occasion and providing the Less Important Guaranteed Budget to the second task (45) at a first possible occasion, wherein upon the first task (44) determining at some point during execution that the first task (44) can execute properly with the More Important Guaranteed Budget only, said conditional budget monitor (46) sending a reservation command to the scheduler (43) including only the More Important Guaranteed Budget for the first task (44) and including the Conditionally Guaranteed Budget Margin along with the Less Important Guaranteed Budget for the second task (45) if the More Important Guaranteed Budget has been depleted but not if the More Important Guaranteed Budget Margin has not been depleted;
wherein upon the first task (44) subsequently determining that it now requires the Guaranteed Budget Margin, and communicating this to the conditional budget monitor (46), if when the Guaranteed Budget Margin was previously released by the first task (44) the More Important Guaranteed Budget had not been depleted and therefore the Conditionally Guaranteed Budget Margin had not been provided to the second task (45), the conditional budget monitor (46) immediately sending a reservation command to the scheduler (43) including the Guaranteed Budget Margin and the More Important Guaranteed Budget to the first task (44) and the Less Important Guaranteed Budget only to the second task (45); and
wherein upon the first task (44) subsequently determining that it now requires the Guaranteed Budget Margin, and communicating this to the conditional budget monitor (46), if when the Guaranteed Budget Margin was previously released by the first task (44) the More Important Guaranteed Budget had been depleted and therefore the Conditionally Guaranteed Budget Margin had been provided to the second task (45), the conditional budget monitor (46) sending a reservation command to the scheduler (43) including the Guaranteed Budget Margin and the More Important Guaranteed Budget to the first task (44) and the Less Important Guaranteed Budget only to the second task (45), and the conditional budget monitor (43) informing the second task (45) of withdrawal of the Conditionally Guaranteed Budget Margin.

20. The apparatus (30) according to claim 19, wherein depletion of the More Important Guaranteed Budget enables provision of the Conditionally Guaranteed Budget Margin in one or more subsequent More Important Guaranteed Budget periods.

21. A method (500) for controlling multiple tasks in a system comprising:
accounting (508) a time a task remains blocked to a budget associated with the task; and
maintaining (508) the budget with the blocked task during the period the task remains blocked.

22. The method (500) according to claim 21, further comprising:
sending (507) a message if either the first or second task becomes blocked indicating a blocked status for the first or second task.

23. The method (500) according to claim 21, further comprising:
determining (509) if a blocking time exceeds a predetermined threshold.

24. The method (500) according to claim 23, further comprising:
implementing (510) budget withdrawal and reallocation technique of the blocking time exceeds the predetermined threshold.

25. The method (500) according to claim 23, further comprising:
continuing (508) to account the blocking time to the blocked task while the blocked task remains blocked or until a current budget expires.

26. An apparatus (30) comprising:
a task (34);
an allocation mechanism (32) to allocate a budget and a budget margin to the task; and
a scheduler (33) providing the budgeted amount to the task (34), wherein upon the task (34) becoming blocked, the blocked task (34) sends a message to the scheduler (33) indicating a blocked status, wherein the scheduler (33) continues to provide the Budget and the Budget Margin to the blocked task (34) and accounts a blocking time to a budget of the blocked task until the blocked task (34) becomes unblocked or the budget period expires.

27. A method (600) for controlling multiple tasks in a system comprising:
providing (605) a gain time to a gain time consumer at a lower priority than a priority of a gain time producer; and
providing (605) the gain time to the gain time consumer at a higher priority than a priority of a next regular budget.

28. The method (600) according to claim 27, further comprising:
establishing (601) a first priority for a first task, said first task being the gain time producer;
establishing (602) a second priority for a second task, the second task being the gain time consumer, said second priority being lower than the first priority; and
establishing (603) an intermediate priority between the first and second priority, wherein said providing (605) the gain time to the gain time consumer further comprises providing the gain time to the second task at the intermediate priority.

29. An apparatus (70) comprising:
a first task (74) having a first priority execution level;
a second task (75) having a second priority execution level lower than the first priority level; and
a scheduler (73) determining gain time and allocating gain time among the first and second tasks, and allocating gain time from the first task to the second task at an intermediate level higher than the second priority level and lower than the first priority level and reallocating gain time back to the first task at the first priority level.

30. The apparatus (70) according to claim 29, wherein the scheduler provides gain time to a gain time consumer at a lower priority than a priority of a gain time producer and provides gain time to the gain time consumer at a higher priority than a priority of a next regular budget.

31. The apparatus (70) according to claim 30, wherein the scheduler establishes a first priority for a first task (74), said first task (74) being the gain time producer and establishes a second priority for a second task (75), the second task being the gain time consumer, said second priority being lower than the first priority, and establishes an intermediate priority between the first and second priority, wherein said providing the gain time to the gain time consumer further comprises providing the gain time to the second task at the intermediate priority.

32. A method (800) for controlling multiple tasks in a system comprising:
providing (805) a conditionally guaranteed budget to a less important task at a lower priority than a priority of a more important budget; and
providing (805) the conditionally guaranteed budget to the less important task at a priority immediately below a priority of the more important guaranteed budget being provided to the more important task.

33. The method according to claim 32, further comprising:
providing the conditionally guaranteed budget at the intermediate priority to the less important task but at a priority higher than a less important guaranteed budget being provided to the less important task.

34. The method according to claim 32, further comprising:
providing the conditionally guaranteed budget at the intermediate priority to the less important task but a priority lower than a less important guaranteed budget being provided to the less important task.

35. The method (800) according to claim 32, further comprising:
establishing (801) a first priority level for a budget of the higher important task; and
establishing (803) an next priority level just below the first priority level, wherein said providing (805) the conditionally guaranteed budget margin to the lower important task further comprises providing the conditionally guaranteed budget margin to the lower important task at the intermediate priority level.

36. The method according to claim 35, further comprising:
establishing (802) a second priority level for a budget of the less important task, said second priority level being lower than the first priority level.

37. The method according to claim 35, further comprising:
establishing (802) a second priority level for a budget of the less important task, said second priority level being higher than the first priority level.

38. The method (800) according to claim 32, further comprising:
determining (804) that the first task does not require the guaranteed budget margin and then providing (805) the conditionally guaranteed budget to the less important task at the intermediate priority.

39. The method (800) according to claim 38, further comprising:
determining (806) that the first task now requires the guaranteed budget margin; and
returning (807) the guaranteed budget margin to the first task for consumption by the first task at the first priority level.

40. An apparatus (90) comprising:
a first task (94) having a first priority execution level for consuming a first budget and a guaranteed budget margin;
a second task (95) having a second priority execution level different than the first priority level for consuming a second budget; and
a scheduler (93) providing the guaranteed budget margin to the first task at the first priority level and providing a conditionally guaranteed budget margin to the second task at an intermediate level immediate below the first priority level.

41. The apparatus according to claim 40, wherein the second priority level is lower than the first priority level.

42. The apparatus according to claim 40, wherein the second priority level is higher than the first priority level.
